(19) United States
(12) Patent Application Publication
(10) Pub. No.: US 2022/0272970 A1
(43) Pub. Date: Sep. 1, 2022

(54) NO SCENT NO BITE

(71) Applicant: Pouch Pac Innovations, LLC, Sarasota, FL (US)

(72) Inventors: R. Charles Murray, Sarasota, FL (US); John Harlin, Sarasota, FL (US)

(21) Appl. No.: 17/636,661

(22) PCT Filed: Aug. 21, 2020
(86) PCT No.: PCT/US2020/047397

§ 371 Date: Feb. 18, 2022

Related U.S. Application Data
(60) Provisional application No. 62/889,730, filed on Aug. 21, 2019.

(51) Int. Cl. A01N 31/02; A01N 25/04

(52) U.S. Cl. CPC A01N 31/02; A01N 25/04; A01P 17/00

(57) ABSTRACT

A topical mosquito control product includes active and inert ingredients. The active ingredients include geraniol. The inert ingredients include natural materials and may include edible oil such as sunflower oil, Oleic Acid, monolaurin, octanoic acid, decanoic acid, lauric acid, lecithin and water wherein the topical mosquito repellent composition has no essential oil scent.

### CROSS REFERENCE TO RELATED APPLICATION

This application claims priority to U.S. Application Ser. No. 62/889,730 filed on Aug. 21, 2019, the entire disclosure of which is hereby incorporated by reference.

### FIELD OF THE INVENTION

The instant application is directed to a formulation for a topical mosquito repellent.

### BACKGROUND OF THE INVENTION

Mosquito bites often cause annoying reactions in humans and animals. Additionally, mosquito bites are a vector for many types of disease including: malaria, Dengue Fever, Chikungunya, West Nile and Zika viruses as well as other forms of disease.

There is a need to prevent mosquitos from biting a host to lessen the discomfort of a bite reaction and to prevent the potential spread of a disease.

Accordingly, a natural non-toxic ingredient based topical product that prevents bites to humans and animals would be desirable.

### DETAILED DESCRIPTION OF THE EMBODIMENTS

Mosquito bites may transmit diseases and cause reactions to people that are bitten. Various repellant compositions have been utilized in prior art repellant compositions. One such repellant, DEET, is often used in mosquito repellant compositions. DEET has been questioned as to its toxicity in higher amounts for use with humans and other subjects. There is therefore a need in the art for an improved and safe topical mosquito repellant composition.

In one aspect, there is disclosed herein a formulation that may be utilized as a topical lotion or spray to repel mosquitos. The formulation may include organic and chemical-free compositions that will protect humans and other animals from blood-seeking insects such as mosquitos.

### Example 1

In one aspect, the composition may include the following formula:

| | Percentage | CAS | |
|---|---|---|---|
| Ingredient Active | | | |
| Geraniol | 0.5 | 106-24-1 | PLUS-MINUS 40% |
| Ingredient Inert | | | |
| Sunflower Oil | 38 | 8001-21-6 | PLUS-MINUS 35% |
| Oleic Acid | 10.2 | 112-80-1 | Range 6-12% |
| Beeswax | 10 | 8012-89-3 | PLUS-MINUS 30% |
| Water | 22 | 7732-18-5 | PLUS-MINUS 35% |
| Monolaurin | 5 | 142-18-7 | Range 3-6% |
| Steric Acid | 2 | 57-11-4 | Range 2-5% |
| Octanoic Acid | 4 | 124-7-2 | 3 to 11% range |
| Decanoic Acid | 4 | 334-48-5 | 3 to 11% range |
| Lauric Acid | 4 | 143-07-7 | 3 to 10% range |
| Lecithin | 0.3 | 8001-43-5 | PLUS-MINUS 25% |

The composition may include bee's wax, edible oil such as sunflower oil, Geraniol, Oleic Acid (CH₃(CH₂)₇CH═CH(CH₂)₇COOH), monolaurin (H₃C(CH₂)₁₀COOCH₂CH(OH)CH₂OH), steric acid (CH₃(CH₂)₁₆COOH), octanoic acid (CH₃(CH₂)₆COOH), decanoic acid (CH₃(CH₂)₈COOH), lauric acid (CH₃(CH₂)₁₀COOH), lecithin and water.

The bee's wax may be present in an amount of from 7 to 13% by weight. The sunflower oil may be present in an amount of from 25 to 51% by weight. The Oleic Acid may be present at about 6 to 12% by weight. Monolaurin may be present at about 3 to 6% by weight. The octanoic acid may be present at about 3 to 11% by weight. The Geraniol may also be present in an amount of from 0.3% to 0.7% by weight. The decanoic acid may be present in an amount of from 3 to 11% by weight. Water may be present in an amount of from 15 to 30% by weight. Steric acid may be present in an amount of from 2 to 5% by weight. Lauric acid may be present in an amount of from 3 to 10% by weight.

Additionally, the composition may include powdered ingredients such as Lecithin present at about 0.3% by weight. The weight percentages are based on a total weight of the composition.

As described above, the composition may include active ingredients and inactive ingredients. The Geraniol may be classified as an active ingredient wherein the Sunflower Oil, Oleic Acid, Beeswax, Water, Monolaurin, Stearic acid, Octanoic Acid, Decanoic Acid, Lauric Acid and Lecithin may be considered inert or inactive ingredients.

The composition was made according to the following procedure. The Sunflower oil was heated from room temperature to 145 to 160 degrees F. in a mixing vat under agitation. The lecithin and water were added to the composition when the temperature approaches 100 F. The mixture is heated and agitated until about 125 degrees F. and a shearing mechanism is activated and maintained until the mixture contains no grit. Next, Monolaurin, Stearic acid, Octanoic Acid, Decanoic Acid, Lauric Acid are added to the composition under agitation. Next the bee's wax is added at temperature of 145 F and again the shearing mechanism is activated and maintained until the mixture contains no grit.

The composition is maintained under agitation and heat is turned off from the composition. Geraniol is then added and the composition cools to about 125-130 F. The composition is agitated and sheared for a specified time dependent upon the size of the batch. After which time the lotion may be packaged.

In another aspect, the formula may be in the form of a spray on composition.

### Example 2

In one aspect, the composition may include the following formula:

| | Percentage | CAS | |
|---|---|---|---|
| Ingredient Active | | | |
| Geraniol | 0.4 | 106-24-1 | PLUS-MINUS 40% |
| Ingredient Inert | | | |
| Sunflower Oil | 24.4 | 8001-21-6 | PLUS-MINUS 35% |
| Oleic Acid | 8 | 112-80-1 | Range 7-10% |
| Water | 47 | 7732-18-5 | PLUS-MINUS 35% |
| Monolaurin | 3 | 142-18-7 | Range 2-5% |
| Octanoic Acid | 5.5 | 124-7-2 | 3 to 11% range |
| Decanoic Acid | 5.5 | 334-48-5 | 3 to 11% range |
| Lauric Acid | 5.5 | 143-07-7 | 3 to 10% range |
| Lecithin | 0.7 | 8001-43-5 | PLUS-MINUS 25% |

The sunflower oil may be present in an amount of from 15 to 33% by weight. The Oleic Acid may be present at about 7 to 10% by weight. Monolaurin may be present at about 2 to 5% by weight. The octanoic acid may be present at about 3 to 11% by weight. The Geraniol may also be present in an amount of from 0.3% to 0.7% by weight. The decanoic acid may be present in an amount of from 3 to 11% by weight. Water may be present in an amount of from 30 to 63% by weight. Lauric acid may be present in an amount of from 3 to 10% by weight.

Additionally, the composition may include powdered ingredients such as Lecithin present at about 0.7% by weight. The weight percentages are based on a total weight of the composition.

As described above, the composition may include active ingredients and inactive ingredients. The Geraniol may be classified as an active ingredient wherein the Sunflower Oil, Oleic Acid, Water, Monolaurin, Octanoic Acid, Decanoic Acid, Lauric Acid and Lecithin may be considered inert or inactive ingredients.

The composition was made according to the following procedure. Add water and sunflower oil, heat to 140° F. to 160° F. to take into solution. Put mixture through shear pump and add rest of ingredients.

The efficacy of the formulas provided in the examples may be attributed to various properties. In one aspect, the fatty acids present in the composition are not volatile and provide a long lasting product when applied to the skin of a user. Further, the Oleic Acid while an inert ingredient may have properties that deter or repel insects. The three other acids Octanoic Acid (C8:0), Decanoic Acid (C10:0), Lauric Acid (C12:0 may have properties that deter or repel insects like Oleic Acid. Additionally, the monolaurin present acts as an antibacterial agent and holds bacterial development in skin at bay for at least an 8 hour working day. Bacterial odor is known to attract mosquitoes.

In one aspect, the compositions described above have no appreciable essential oil odor as sensed by the human nose. In other words, the composition may be considered scent free. A scent free insect repellent may have various advantages over current repellents. For example, people with sensitivity to strong scents may prefer such a composition. People who wish to remain undetected by their scent may prefer such a composition. People around animals may prefer such a composition to lessen a reaction by an animal to the insect repellent.

Testing:

The deterrent effect of the above-described compositions of examples 1-2 was tested in a controlled environment. In vitro laboratory tests were conducted and measured and compared to DEET and nontreated control groups for yellow fever mosquitos, Aedes aegypti. Bioassays were conducted in nine six-chambered Plexiglas K & D modules stocked with female Aedes aegypti mosquitos. Five female mosquitos were aspirated into each of the six chambers of the nine modules. Repellant treatments were applied at 26.7 microliters with a pipette and spread with a small brush over 12 square centimeter sections of organdy cloth attached to a flat plastic template containing rectangular openings. The treated cloth covered template was fitted between the K & D module and a lower Plexiglas unit. The lower Plexiglas unit contained shallow surface wells filled with a blood substitute (CDTA and ATP) and covered with a moistened collagen membrane. The blood substitute was heated to 38° C. using water pumped through hose lines attached to the lower units and a water bath supplied with a temperature controlled inversion circulator. Mosquitos were exposed to the treated surfaces by opening sliding doors beneath the modules for 90-second biting counts at five post-treatment time intervals from 1 to 6 hours. Fresh, untreated mosquitos are used for each time interval.

The bite counts were tabulated and utilized for statistical analysis. The percent repellency of the formulations as described above was more effective than DEET over the five time periods. As measured by percent repellency, The compositions of examples 1 and 2 performed better than the Cutter Skinsations 7% DEET at all time intervals.

Repellency for the compositions of example 1 and example 2 ranged from 93-85% at 0-8 hrs. post-treatment, respectively. The greatest repellency for Cutter Skinsations was 87% at 1 hr. post-treatment. Repellency was slightly lower through 4 hrs. and then dropped to 48% and 39%, respectively, at 6 and 8 hrs. post-treatment for the DEET product. The compositions of examples 1 and 2 maintained 85% repellency for greater than 8 hours unlike the DEET product.

The bar graph below shows these results.

The average for all five time periods demonstrates the repellency of 87% for the compositions as described herein compared to 62% for DEET.

The experimental results demonstrate a very high effectiveness of repellency utilizing a safe and effective organic product that is both DEET and chemical free. The testing has demonstrated that the product is effective in repelling mosquitos and in particular the yellow fever mosquito which may potentially carry West Nile virus.

Sarasota, Fla.

The compositions of examples 1 and 2 were applied to 10 people in a swamp-type environment in central Sarasota, Fla. The tests indicate 100% effectiveness in a natural environmental setting with high mosquito infestation. After application of the lotion of examples 1-2 as presented in the embodiments disclosed above, it was observed that the repellency is 100% and with no application of the product the number of bites normally exceeds 10 in a 5 minute exposure.

Additionally, the 10 people reported no appreciable essential oil odor of the product after it was applied to their bodies.

1. A topical mosquito repellent composition comprising:
a lotion including active and inert ingredients, wherein the active ingredients include geraniol and the inert ingredients include bee's wax, edible oil such as sunflower oil, Oleic Acid (CH₃(CH₂)₇CH═CH(CH₂)₇COOH), monolaurin (H₃C(CH₂)₁₀COOCH₂CH(OH)CH₂OH), steric acid (CH₃(CH₂)₁₆COOH), octanoic acid (CH₃(CH₂)₆COOH), decanoic acid (CH₃(CH₂)₈COOH), lauric acid (CH₃(CH₂)₁₀COOH), lecithin and water wherein the topical mosquito repellent composition has no scent.

2. The topical mosquito repellent composition of claim 1 wherein the bee's wax is present in an amount of from 7 to 13% by weight, the sunflower oil is present in an amount of from 25 to 51% by weight, the oleic Acid is present at about 6 to 12% by weight, monolaurin is present at about 3 to 6% by weight, octanoic acid is present at about 3 to 11% by weight, geraniol is present in an amount of from 0.3% to 0.7% by weight, decanoic acid is present in an amount of from 3 to 11% by weight, water is present in an amount of from 15 to 30% by weight, steric acid is present in an amount of from 2 to 5% by weight, lauric acid is present in an amount of from 3 to 10% by weight.

3. A method of repelling insects comprising:
applying a lotion composition to a body and exposing insects to the lotion, the lotion including active and inert ingredients, wherein the active ingredients include geraniol and the inert ingredients include bee's wax, edible oil such as sunflower oil, Oleic Acid (CH₃(CH₂)₇CH═CH(CH₂)₇COOH), monolaurin (H₃C(CH₂)₁₀COOCH₂CH(OH)CH₂OH), steric acid (CH₃(CH₂)₁₆COOH), octanoic acid (CH₃(CH₂)₆COOH), decanoic acid (CH₃(CH₂)₈COOH), lauric acid (CH₃(CH₂)₁₀COOH), lecithin and water wherein the topical mosquito repellent composition has no scent.

4. The method of claim 3 wherein bee's wax is present in an amount of from 7 to 13% by weight, the sunflower oil is present in an amount of from 25 to 51% by weight, the oleic Acid is present at about 6 to 12% by weight, monolaurin is present at about 3 to 6% by weight, octanoic acid is present at about 3 to 11% by weight, geraniol is present in an amount of from 0.3% to 0.7% by weight, decanoic acid is present in an amount of from 3 to 11% by weight, water is present in an amount of from 15 to 30% by weight, steric acid is present in an amount of from 2 to 5% by weight, lauric acid is present in an amount of from 3 to 10% by weight.

5. A topical mosquito repellent composition comprising:
a spray including active and inert ingredients, wherein the active ingredients include geraniol and the inert ingredients include inert ingredients include edible oil such as sunflower oil, Oleic Acid (CH₃(CH₂)₇CH═CH(CH₂)₇COOH), monolaurin (H₃C(CH₂)₁₀COOCH₂CH(OH)CH₂OH), octanoic acid (CH₃(CH₂)₆COOH), decanoic acid (CH₃(CH₂)₈COOH), lauric acid (CH₃(CH₂)₁₀COOH), lecithin and water wherein the topical mosquito repellent composition has no scent.

6. The topical mosquito repellent composition of claim 5 wherein sunflower oil is present in an amount of from 15 to 33% by weight, oleic Acid is present at about 7 to 10% by weight, monolaurin is present at about 2 to 5% by weight, octanoic acid is present at about 3 to 11% by weight, geraniol is present in an amount of from 0.3% to 0.7% by weight, decanoic acid is present in an amount of from 3 to 11% by weight, water is present in an amount of from 30 to 63% by weight, lauric acid is present in an amount of from 3 to 10% by weight.

7. A method of repelling insects comprising:
applying a lotion composition to a body and exposing insects to the lotion, the lotion including active and inert ingredients, wherein the active ingredients include geraniol and the inert ingredients include edible oil such as sunflower oil, Oleic Acid (CH₃(CH₂)₇CH═CH(CH₂)₇COOH), monolaurin (H₃C(CH₂)₁₀COOCH₂CH(OH)CH₂OH), octanoic acid (CH₃(CH₂)₆COOH), decanoic acid (CH₃(CH₂)₈COOH), lauric acid (CH₃(CH₂)₁₀COOH), lecithin and water wherein the topical mosquito repellent composition has no scent.

8. The method of claim 7 wherein sunflower oil is present in an amount of from 15 to 33% by weight, oleic Acid is present at about 7 to 10% by weight, monolaurin is present at about 2 to 5% by weight, octanoic acid is present at about 3 to 11% by weight, geraniol is present in an amount of from 0.3% to 0.7% by weight, decanoic acid is present in an amount of from 3 to 11% by weight, water is present in an amount of from 30 to 63% by weight, lauric acid is present in an amount of from 3 to 10% by weight.
